(19) United States
(12) Patent Application Publication
(10) Pub. No.: US 2020/0097735 A1
(43) Pub. Date: Mar. 26, 2020

(54) System and Method for Display of Object Movement Scheme

(71) Applicant: OOO ITV Group, Moscow (RU)

(72) Inventor: Murat K. Altuev, Moscow (RU)

(21) Appl. No.: 16/568,214

(22) Filed: Sep. 11, 2019

(30) Foreign Application Priority Data
Sep. 20, 2018 (RU) 2018133314

(51) Int. Cl. G06K 9/00; H04W 4/38; H04W 4/80; H04W 4/029

(52) U.S. Cl. CPC G06K 9/00771; H04W 4/38; H04W 4/80; G06K 9/00744; G06K 9/00275; G06K 9/00664; H04W 4/029

(57) ABSTRACT

The system for display the movement of objects in the controlled area contains multiple sensors or devices, memory, image display unit, graphical user interface, data input/output device, and data processing device. The data processing device is configured to receive a request, as well as the search criteria from the user to perform the search for the object data. Drawing and display of the object movement scheme in the site plan using the data obtained from the various sensors and/or devices that determine specific position of the object at specific points of time is achieved.

### RELATED APPLICATIONS

This application claims priority to Russian Patent Application No. RU 2018133314, filed Sep. 20, 2018, which is incorporated herein by reference in its entirety.

### FIELD OF THE INVENTION

The invention refers to the field of analysis and further visualization of data, and particularly to technologies aimed at searching for data about objects of interest and drawing a scheme of movement of the object of interest on the controlled area's plan according to the received data.

### BACKGROUND

It is well known there are currently many systems capable of receiving/collecting data used for further analysis to identify information about the objects of interest.

Such systems include, for example, Access Control System (ACS). Many guarded enterprises are equipped with such systems. In general, a typical ACS is a set of hardware and software security features aimed at restricting and registering entry and exit of the objects (people, vehicles) in a specific area through the check points. Whenever a person put their personal identifier (card, pass) to the ACS reader, the data about this event is saved in the database. Based on the data received, it is possible to track the movement of objects through the protected area and calculate the time of the object's stay in a certain place.

More and more often, ACSs are integrated with video surveillance systems, which are usually hardware and software or equipment that use computer vision methods for automated data collection based on streaming video analysis.

Video surveillance systems (VSS) are based on image processing and pattern recognition algorithms that allow conducting video analysis without direct involvement of a person. Depending on specific purposes, VSS systems can perform many functions, such as: object detection, tracking the object movement, object identification, search for the objects of interest, etc. VSS are more illustrative than ACSs.

There are situations when it is necessary to track the movement of a certain person on the controlled area for a certain period of time, thus, the movement is recorded by different security system sensors, as well as by the video surveillance cameras. In view of the fact that the large volume of data from different tracking devices, it is often difficult for the security operator to quickly and clearly understand the entire movement.

Thus, the main drawback of systems from invention background is lack of quick, accurate, and clear display of the results after analyzing the data received from different object tracking systems.

In the background of the invention, there is a solution disclosed in US 2011/0103773 A1, published 5 May 2011, which describes a system and methods of searching for objects of interest in the captured video, thus, the method contains: record of video from multiple scenes; saving the video on multiple storage items; acquiring the request for the final video of the object of interest that has passed at least two scenes from multiple scenes; in response to the request, searching for the first part of the video that contains the object of interest the first storage item; processing the first part of the video to determine the object movement direction; selecting the second storage item from multiple storage items in which the object of interest can be searched for depending on the movement direction; search in the second item storing the second part of the video that contains the object of interest; and matching the first part of the video with the second part of the video to create a summary video.

The main drawback of this solution is lack of visual representation of the scheme of object's movement in site plan. In addition, this solution analyses only video data, without taking into consideration the data received from other sensors, and the analysis of data and search for objects is carried out in several elements of storage, rather than in one common archive.

In technical terms, the closest solution was disclosed in U.S. Pat. No. 9,208,226 B2, publ. Aug. 12, 2015, which describes the device for generating the video material, containing: video object indexing unit configured to recognize objects by storing and analyzing the video received from several surveillance cameras; video object search unit configured to compare the accepted search conditions with the received object's metadata and then to display the search results, including information about at least one object that matches the search criteria; video generation unit configured to generate video proof by combining only those videos which containing a specific object selected from the search results; whereby, the video data generation unit contains: video editing unit configured to generate video proof by extracting the sections that include a particular object from the saved videos and then combining these sections; forensic video generation unit configured to generate forensic data about the saved videos and generated videos and then to store the generated video evidence and forensic data in digital storage format; and a path analysis unit configured to receive a specific object path between multiple surveillance cameras by analyzing correlations between the search results.

The main drawback of this solution is inability to jointly analyze the data obtained from various sensors and devices that determine position of the objects of interest for further drawing of an accurate and illustrative scheme of the object movement in the controlled area in the site plan.

### BRIEF SUMMARY

The claimed technical solution is aimed to eliminate the disadvantages of the previous background of the invention and develop the existing solutions.

Technical result of the claimed invention is to ensure drawing and display of the object movement scheme in the site plan using the data obtained from the various sensors and/or devices that determine specific position of the object at specific points of time.

This technical result is achieved due to the fact that the system for displaying the object movement scheme in the controlled area contains: multiple sensors and/or devices that determine specific location of objects at set points of time; memory that stores the archive of data identifying the objects at specific location in a certain point of time, whereby the said data are received in real time from the said sensors and/or devices; image display device; graphical user interface, I/O device; at least one data processing device configured to perform the stages that include:

receiving request from the user and search criteria through the graphical user interface to perform a search for data about at least one object; performing the search for data about at least one object in the data archive; receiving a dataset describing the movement of at least one set object over the controlled terrain with data received from different sensors and/or devices according to the search criteria at different points of times; automatic drawing of the object movement scheme in the site plan of the controlled area based on the received data set; displaying the above mentioned object movement scheme on the image display device.

This technical result is also achieved by a way of displaying an object movement scheme performed by a computer system containing at least one data processing device and a memory that stores the archive of data identifying the objects in a particular location at a certain point of time, whereby the said data is received from a variety of sensors and/or services in real time; whereby this method contains stages at which:

receive a request from the user, as well as the search criteria to perform a search for the data about at least one object through the graphical user interface; perform the search for data about at least one object in the data archive; receive a dataset describing the movement of at least one specified object in the controlled area with data being received from multiple sensors and/or devices at different points of time; perform automatic plotting of the object movement scheme on the site plan based on the received data set; display the mentioned object movement scheme on the image display device.

In one particular version of the claimed solution, the sensors and/or devices that detect specific location of the objects at set points of time are at least:

access control system (ACS) readers;

radio bracelets that provide a unique object identifier and its location;

RFID readers;

vehicle registration number recognition devices;

face recognition devices;

devices containing computer vision means.

In another particular version of the claimed solution, the graphical user interface is additionally configured to display the icon of each of the many sensors and/or devices in the controlled area plan.

In another particular version of the claimed solution, the system additionally contains multiple cameras, and the memory is additionally configured to store an archive of video records that are received from multiple cameras in real time.

In another particular version of the claimed solution, the graphical user interface is additionally configured to indicate which specific sensor or device is located within the field of view of each of the multiple cameras.

In another particular version of the claimed solution, at least one data processor is additionally configured:

to correlate the data received from sensors and/or devices with the corresponding cameras and the time intervals;

to receive a set of video intervals containing at least one specific object, whereby the mentioned video intervals are received from different cameras at different times;

to add the received video intervals to the corresponding sensors and/or devices in the scheme of object movement in the controlled area.

In another particular version of the claimed solution, at least one data processor is additionally configured to automatically update the object's movement scheme whenever new video intervals are added to the set of video intervals, in accordance with the new information received.

In another particular version of the claimed solution, the graphical user interface is additionally configured to allow the system user to select at least one interval in the received set of video intervals and delete it from the set of video intervals, if the selected interval was added to the set of video intervals by mistake.

In another particular version of the claimed solution, the graphical user interface is additionally configured so that when the operator clicks on the sensor or device icon in the object movement scheme the video interval from the corresponding camera is automatically played back, and when the operator clicks on the video interval, transition to the sensor or the device corresponding to the mentioned video interval is carried out automatically.

In another particular version of the claimed solution, the graphical user interface is additionally configured to display object's movement on the object movement scheme by arrows from one sensor or device to another sensor or device.

In another particular version of the claimed solution, the stroke length of each arrow is directly proportional to the movement speed of the specified object between sensors and/or devices, that is, the higher the speed, the shorter the stroke of the arrow.

In another particular version of the claimed solution, the graphical user interface is additionally configured to display the time of the object's movement from one sensor or device to another sensor or device in the object movement scheme by above mentioned arrow.

In another particular version of the claimed solution, if the time interval from the corresponding camera corresponds to the sensor or device on the object movement scheme, the duration of the received video interval is displayed under the icon of the corresponding sensor or device.

In another particular version of the claimed solutions, the site plan is an image or geo-information system (GIS), such as an Open Street Map.

This technical result is also achieved by a computer-readable data carrier containing instructions executed by the computer processor for implementation of options of displaying the object movement scheme in the controlled area.

### BRIEF DESCRIPTION OF THE SEVERAL VIEWS OF THE DRAWINGS

FIG. 1—block diagram of the system for displaying the object movement scheme in the controlled area.

FIG. 2—example of the object movement scheme displayed in the site plan.

FIG. 3—block diagram of one of the options for implementing the method of displaying the object movement scheme in the controlled area.

### DETAILED DESCRIPTION

Description of the approximate embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The claimed technical solution in its various implementation options can be implemented in the form of computer systems and methods for displaying the object movement scheme in the controlled area, as well as in the form of a computer-readable data carrier.

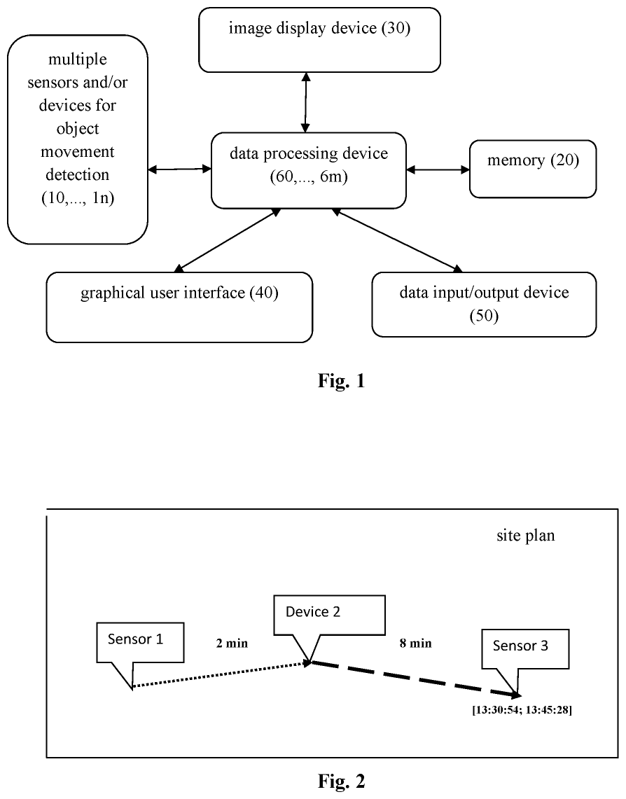

FIG. 1 shows a block diagram of one of the options for implementing the method of displaying the object movement scheme in the controlled area. A computer system includes: multiple sensors and/or devices that detect a specific location of objects at specific points of time (10, . . . , 1n); memory (20); image display device (30); graphical user interface (40); data input/output device (50); and at least one data processing device (60, . . . , 6m).

In this context, computer systems may be any hardware- and software-based computer systems, such as personal computers, smartphones, laptops, tablets, etc.

The sensors and/or devices that detect specific location of the objects at set points of time are at least: ACS readers; radio bracelets that provide a unique object's identifier and its location; RFID tag readers; vehicle number recognition devices; face recognition devices; and devices that contain computer vision means (including video cameras).

The data processing device may be a processor, microprocessor, computer, PLC (programmable logic controller) or integrated circuit, configured to execute certain commands (instructions, programs) for data processing. The processor can be multi-core, for parallel data processing.

Memory devices may include, but are not limited to, hard disk drives (HDDs), flash memory, ROMs (read-only memory), solid state drives (SSDs), etc.

In the context of this claim, the image display device is the display/screen.

The graphical user interface (GUI) is a system of tools for user interaction with the computing device based on displaying all system objects and functions available to the user in the form of graphical screen components (windows, icons, menus, buttons, lists, etc.). Thus, the user has random access via data input/output devices to all visible screen objects—interface units—which are displayed on the display.

The data input/output device can be, but is not limited to, mouse, keyboard, touchpad, stylus, joystick, trackpad, etc.

It should be mentioned that any other devices known in the background of the invention, for example, the devices that are described in more detail below, can be integrated in the system;

the given system may contain multiple cameras the field of view of which cover sensors and/or devices that detect a particular location of the objects at certain points of time.

In order to further understand the nature of the proposed solution, it is necessary to clarify that the site plan is a kind of a topographic map or a drawing of a small area in a given scale. The site plan is either an image (in .jpg or .png format) or data from the geographic information system (GIS), such as an Open Street Map. All stationary sensors and/or devices that determine specific location of objects at certain points of time used by the security system are linked to the site plan.

It should be explained that the system memory stores the archive of data that identifies the objects at a certain location at a certain point of time. This data is received from multiple sensors and/or devices available in the computer system in real time.

The following is an example of how the above system works to display the scheme of object's movement in the controlled area.

Suppose that the police officer needs to obtain all available data from the data archive of the security system which describes the movement of a robbery suspect. The data is required for a certain date of the crime, for example, May 12, 2016. The police officer (hereinafter referred to as the operator) has access to the stated system for displaying the scheme of object's movement in the controlled area.

First of all, the system operator enters a request via the graphical user interface to search for data about at least one specific person or any other required object of interest (e.g. a vehicle). In addition to the search request, the operator sets specific search criteria to improve the search accuracy and speed.

The stated solution implies conducting the search by any available means or method known from the background of the invention. For example, if the operator has a photo of the person of interest and a person's ACS card number, the search may also be performed on the basis of data from the ACS. If there is a registration number of a vehicle of interest, the search can be performed by vehicle registration numbers.

Then, the obtained data is used to search for data about the required object in a certain period of time. At least one object is searched for by the specified search criteria using the automated search tools. It should be noted that, at this stage, the search can be additionally performed manually by the system user.

The search result is a data set that characterizes the movement of at least one specified object in the controlled area. This data was obtained from different sensors and/or devices that detect specific location of objects in certain points of time according to the search criteria, because the object of interest has moved in the zones of several of the many sensors and/or devices within the required period of time.

Further, the system performs automatic drawing of the object movement scheme on the site plan based on the received data set.

In the end, the image display device displays the mentioned object movement scheme. To enhance the clearness, the graphical user interface is additionally configured to display the icon of each of the many sensors and/or devices in the controlled area plan. The icons can be displayed either in the same way or differ for each specific device.

In one of the alternatives, the computer system contains many cameras in addition to the sensors and/or devices mentioned above. In this case, the graphical user interface is additionally configured to indicate which specific sensor or device is located within the field of view of each of the multiple cameras.

In addition, the system memory is configured with an option to store the archive of video received from multiple cameras in real time. In the process of loading into memory, all video data is analyzed to form metadata characterizing the data on all objects in the video. In this case, metadata is detailed information about all objects moving in the field of view of each camera (motion trajectories, face descriptors, recognized car registration numbers, etc.). The obtained metadata is also stored in the system memory. Subsequently, the received metadata is applied for the faster search as well as for unlimited number of searches for the specified objects.

If the system contains multiple cameras, the data processing units are additionally configured to:

to correlate the data received from sensors and/or devices with the corresponding cameras and the time intervals;

to receive a set of video intervals containing at least one specific object, whereby the mentioned video intervals are received from different cameras at different times;

to add the received video intervals to the corresponding sensors and/or devices in the scheme of object movement in the controlled area.

For example, let's suppose that the operator received a set of video intervals consisting of 3 video records. Video record from the first camera lasts 1 minute, video record from the second camera lasts 7 minutes, and video record from the third camera lasts 15 minutes. Each interval corresponds to a specific sensor or device.

It should be mentioned that any system has certain inaccuracy, which may result in further large-scale errors. To eliminate unwanted errors, the system's graphical user interface is configured to allow the system user to select at least one interval in the received video interval set and delete it from the video interval set. For example, the selected interval could be added to the set of video intervals by mistake, which is immediately recognized by the operator. After deleting an error interval, the data processing device automatically updates the displayed object movement scheme.

In another particular version of the claimed solution, at least one data processing device is additionally configured to automatically update the object's movement scheme whenever new video intervals are added to the set of video intervals. For example, the system operator can manually add another video interval he considers to be necessary.

As another example, the automatic drawing of the object movement scheme on the site can be conducted in real time and simultaneously with the search, that is, with each new detected video interval the object movement scheme is redrawn.

Further we will describe the process of displaying the mentioned movement scheme in more detail.

Graphical user interface of the system is configured with possibility to display the icon of each of the multiple stationary sensors and/or devices on the controlled area plan that at any time, regardless of the search being conducted. In this way, the system operator can clearly see where the security devices are located.

In addition, in order to make the movement of the object clearer, the graphical user interface is additionally configured to display the object movement from one sensor or device to another sensor or device with the above-mentioned arrows in accordance with the time of the object detection by each of the mentioned sensors and/or devices. An example of such a movement is shown in FIG. 2 in which the object of interest has moved from the first sensor (e.g. ACS reader) to the second device (e.g. face recognition device), and then from the second device to the third sensor (e.g. another ACS reader located in a different location relative to the first reader).

Thus, the stroke length of each arrow is directly proportional to the movement speed of the specified object between sensors and/or devices, that is, the higher the speed, the shorter the stroke of the arrow.

The graphical user interface is additionally configured to display the time of the object's movement from one sensor or device to another sensor or device in the object movement scheme by the above-mentioned arrow. As shown in FIG. 2, the object moved from the first sensor to the second device in 2 minutes and from the second device to the third sensor in 8 minutes. In view of the fact that the distances between the first sensor and the second device and the second device and the third sensor are almost the same and taking into account the time of moving between them, the strokes of the first arrow are much shorter than those of the second arrow because of the different movement speed.

If the time interval from the corresponding camera corresponds to the sensor or device on the object movement scheme, the duration of the received video interval is displayed under the icon of the corresponding sensor or device. For example, as shown in FIG. 2, there is a specific time interval displayed under the icon of the third sensor, for example [13:30:54; 13:45:28], which means that this sensor corresponds to a 15-minute time interval during which the object of interest was detected.

In addition, to ensure greater interaction and better control of the system, the graphical user interface is configured so that when the operator clicks on the sensor or device icon on the object movement scheme, the interval of video from the corresponding camera (if such an interval exists and was added to the movement scheme at earlier stages) is automatically played back, and when the operator clicks on the video interval, transition to the sensor or device corresponding to the mentioned video interval is performed.

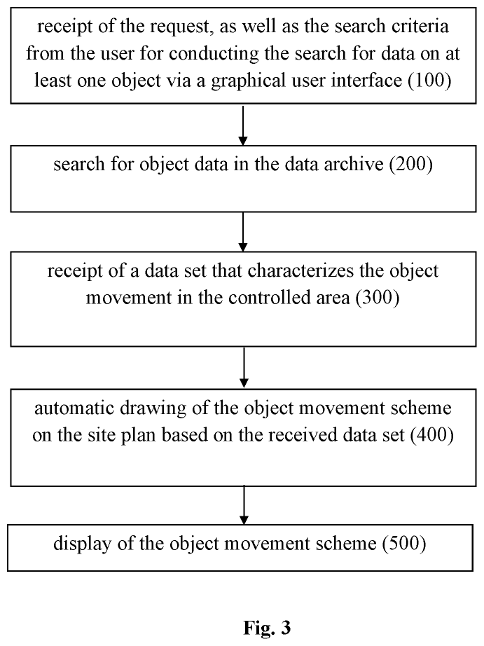

FIG. 3 shows a block diagram of one of the options for implementing the method of displaying the object movement scheme in the controlled area. This method is performed by the computer system containing at least one data processing device and memory that stores the archive of data identifying objects at a certain location at a certain point of time, whereby the mentioned data is obtained from multiple sensors and/or devices in real time. Thus, the specified method contains the stages at which:

Stage (100) the request from the user as well as the search criteria for conducting the search for data on at least one object via a graphical user interface is received;

Stage (200) the search for data on at least one object in the archive is conducted;

Stage (300) the data set characterizing the movement of at least one object in the controlled area is received, whereby the data is received from different sensors and/or devices at different points of time;

Stage (400) the object movement scheme is automatically drawn on the site plan based on the received data set;

Stage (500) the above-mentioned object movement scheme is displayed on the image display device.

It should be mentioned once again that this method is implemented by means of the previously described computer system for displaying the movement of objects in the controlled area and, therefore, it can be expanded and refined by all particular versions that have been already described above for embodiment of this computer system.

Besides, the embodiment options of this group of inventions can be implemented with the use of software, hardware, software logic, or their combination. In this embodiment example, software logic, software, or a set of instructions are stored on one or multiple various conventional computer-readable data carriers.

In the context of this description, a “computer-readable data carrier” may be any to environment or medium that can contain, store, transmit, distribute, or transport the instructions (commands) for their application (execution) by a computer device, such as a personal computer. Thus, a data carrier may be an energy-dependent or energy-independent machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the invention is not limited to the embodiments disclosed and is intended to modify and combine various other features of the embodiments described. For example, it should be understood that this invention implies that, to the possible extent, one or more features of any embodiment option may be combined with one or more other features of any other embodiment option.

1. The system for displaying the scheme of movement of objects in the controlled area, comprising:
multiple sensors and/or devices that determine specific location of objects at certain points of time;
memory that stores the archive of data identifying the objects in a particular location at a certain point of time, whereby the said data is obtained from the said sensors and/or devices in real time;
image display device;
graphical user interface;
data input/output device;
at least one data processing device configured to perform the stages including:
receipt of the request from the user as well as the search criteria for conducting the search for data on at least one object via a graphical user interface;
conducting the search for data on at least one object in the archive;
receipt of the data set characterizing the movement of at least one object in the controlled area, whereby the data is received from different sensors and/or devices at different points of time;
automatic drawing of the object movement scheme on the site plan based on the received data set;
displaying the above-mentioned object movement scheme on the image display unit.

2. The system of claim 1, wherein the comprising if a fact that the sensors and/or devices that detect specific location of the objects at set points of time are at least:
access control system (ACS) readers;
radio bracelets that provide a unique object identifier and its location;
RFID readers;
vehicle registration number recognition devices;
face recognition devices;
devices comprising computer vision means.

3. The system of claim 2, wherein the graphical user interface is additionally configured to display the icon of each of the many sensors and/or devices in the controlled area plan.

4. The system of claim 3, wherein the additionally contains multiple cameras, and the memory is additionally configured to store an archive of video records that are received from multiple cameras in real time.

5. The system of claim 4, wherein the graphical user interface is additionally configured to indicate which specific sensor or device is located within the field of view of each of the multiple cameras.

6. The system of claim 5, wherein the at least one data processing device is additionally configured:
to correlate the data received from sensors and/or devices with the corresponding cameras and the time intervals;
to receive a set of video intervals containing at least one specific object, whereby the mentioned video intervals are received from different cameras at different times;
to add the received video intervals to the corresponding sensors and/or devices in the scheme of object movement in the controlled area.

7. The system of claim 6, wherein the at least one data processor is additionally configured to automatically update the object's movement scheme whenever new video intervals are added to the set of video intervals, in accordance with the new information received.

8. The system of claim 7, wherein the graphical user interface is additionally configured to allow the system user to select at least one interval in the received set of video intervals and delete it from the set of video intervals, if the selected interval was added to the set of video intervals by mistake.

9. The system of claim 6, wherein the graphical user interface is additionally configured so that when the operator clicks on the sensor or device icon in the object movement scheme the video interval from the corresponding camera is automatically played back, and when the operator clicks on the video interval, transition to the sensor or the device corresponding to the mentioned video interval is carried out automatically.

10. The system of claim 6, wherein the graphical user interface is additionally configured to display object's movement on the object movement scheme by arrows from one sensor or device to another sensor or device.

11. The system of claim 10, wherein the stroke length of each arrow is directly proportional to the movement speed of the specified object between sensors and/or devices, that is, the higher the speed, the shorter the stroke of the arrow.

12. The system of claim 11, wherein the graphical user interface is additionally configured to display the time of the object's movement from one sensor or device to another sensor or device in the object movement scheme by above mentioned arrow.

13. The system of claim 12, wherein if the time interval from the corresponding camera corresponds to the sensor or device on the object movement scheme, the duration of the received video interval is displayed under the icon of the corresponding sensor or device.

14. The system of claim 1, wherein the site plan is an image or a geographic information system (GIS), for example, an Open Street Map.

15. The method for displaying the scheme of object's movement in the controlled area performed by a computer system comprising at least one data processing device and a memory that stores the archive of data identifying the objects in a particular location at a certain point of time, whereby the said data is received from a variety of sensors and/or devices in real time; whereby this method contains stages at which:
the request from the user as well as the search criteria for conducting the search for data on at least one object via a graphical user interface is received;
the search for data on at least one object in the archive is conducted;
the data set characterizing the movement of at least one object in the controlled area is received, whereby the data is received from different sensors and/or devices at different points of time;
the object movement scheme is automatically drawn on the site plan based on the received data set;
the above-mentioned object movement scheme is displayed on the image display device.

16. The method of claim 15, wherein the sensors and/or devices are at least:
ASC readers;
radio bracelets that provide a unique object identifier and its location;
RFID tag readers;
vehicle registration number recognition devices;
face recognition devices;
devices containing computer vision means.

17. The method of claim 16, wherein the additionally configured to display the icon of each of the many sensors and/or devices in the controlled area plan.

18. The method of claim 17, wherein the memory is additionally configured to store the archive of video records received from multiple cameras in real time, if the computer system additionally contains many cameras.

19. The method of claim 18, wherein the graphical user interface is additionally configured to indicate which specific sensor or device is located within the field of view of each of the multiple cameras.

20. The method of claim 19, wherein the additionally possibility:
to correlate the data received from sensors and/or devices with the corresponding cameras and the time intervals;
to receive a set of video intervals comprising at least one specific object, whereby the mentioned video intervals are received from different cameras at different times;
to add the received video intervals to the corresponding sensors and/or devices in the scheme of object movement in the controlled area.

21. The method of claim 20, wherein the additionally configured to automatically update the object movement scheme whenever new video intervals are added to the video interval set, according to the received new information.

22. The method of claim 21, wherein the graphical user interface is additionally configured to allow the system user to select at least one interval in the received set of video intervals and delete it from the set of video intervals, if the selected interval was added to the set of video intervals by mistake.

23. The method of claim 20, wherein the graphical user interface is additionally configured so that when the operator clicks on the sensor or device icon in the object movement scheme the video interval from the corresponding camera is automatically played back, and when the operator clicks on the video interval, transition to the sensor or the device corresponding to the mentioned video interval is carried out automatically.

24. The method of claim 20, wherein the graphical user interface is additionally configured to display object's movement from one sensor or device to another sensor or device on the object movement scheme by arrows.

25. The method of claim 24, wherein the stroke length of each arrow is directly proportional to the movement speed of the specified object between sensors and/or devices, that is, the higher the speed, the shorter the stroke of the arrow.

26. The method of claim 25, wherein the graphical user interface is additionally configured to display the time of the object's movement from one sensor or device to another sensor or device in the object movement scheme by above mentioned arrow.

27. The method of claim 26, wherein if the time interval from the corresponding camera corresponds to the sensor or device on the object movement scheme, the duration of the received video interval is displayed under the icon of the corresponding sensor or device.

28. The method of claim 15, wherein the site plan is an image or a geographic information system (GIS), for example, an Open Street Map.

29. Non-transitory computer readable medium storing instructions that, when executed by a computer, cause it to perform the method of claim 15.
